(19) United States
(12) Patent Application Publication
(10) Pub. No.: US 2006/0126006 A1
(43) Pub. Date: Jun. 15, 2006

(54) Non-magnetic frames having a magnetic insert

(75) Inventor: Greg Smith, Plano, TX (US)

Correspondence Address: STORM L.L.P., BANK OF AMERICA PLAZA, 901 MAIN STREET, SUITE 7100, DALLAS, TX, 75202, US

(73) Assignee: E 'lite Optik, Inc., Carrollton, TX (US)

(21) Appl. No.: 11/240,861

(22) Filed: Sep. 30, 2005

Related U.S. Application Data
(60) Provisional application No. 60/706,685, filed on Aug. 9, 2005.
(60) Provisional application No. 60/627,451, filed on Nov. 12, 2004.

(51) Int. Cl. G02C 9/00

(52) U.S. Cl. 351/47

(57) ABSTRACT

The improved eyewear assemblies disclosed herein employ magnetically attractable inserts fitted within a primary lens assembly, which allow for increased usage of plastics in eyewear design. The ability to employ various plastics or composites allows for increased flexibility in design as well as an overall reduction in cost. Thus, the eyewear assembly provides a system that is both stable and easy to use as well as aesthetically pleasing, filling a long-felt need in the industry.

### CLAIM OF PRIORITY

This application claims priority to U.S. Provisional Application No. 60/706,685 entitled “Non-Magnetic Frames Having a Magnetic Insert” and filed on behalf of the inventor Greg Smith, and which is also hereby incorporated by reference for all purposes. This application also claims priority to U.S. Provisional Application No. 60/627,451 entitled “Auxiliary Lens Assembly with Micromagnetic Attachment” and filed on behalf of the inventor Greg Smith, and which is also hereby incorporated by reference for all purposes

### TECHNICAL FIELD OF INVENTION

The present invention relates to eyewear and, in particular, to an eyewear assembly that incorporates a removable auxiliary lens assembly for attachment to a primary lens assembly. Still more specifically, the present invention relates to a primary lens assembly having a non-metallic frame with a magnetically attractable insert configured to magnetically couple to an auxiliary lens assembly.

### BACKGROUND OF THE INVENTION

It has long been desirable to have a removable auxiliary lens assembly attached to eyeglasses with a plastic or composite frame. Specifically, it has been desired to have an eyewear assembly to encompass a wider range of aesthetic features that allow for the use of a plastic or composite frame.

U.S. Pat. No. 6,783,238 to Stepper is directed toward an injection molded plastic frame having a plurality of magnets inserted along the perimeter of each primary lens in the primary lens assembly. An auxiliary lens assembly then couples to the primary lens assembly by use of complementary poles of magnets inserted along the perimeter of the auxiliary lenses in the auxiliary lens assembly.

U.S. Pat. No. 6,412,941 to Xiao is directed toward magnetically coupling an auxiliary lens assembly to a primary lens assembly. However, a shelter or shelf is used in combination with the magnetic assembly, and the primary frames themselves are made of steel to engage the magnets.

U.S. Patent Application No. 2005/0052611 to Cheng is directed toward a magnetic attachment assembly located within the auxiliary bridge. Specifically, the magnets within the auxiliary lens assembly couple to complementary magnets located in the primary bridge.

U.S. Pat. No. 6,834,951 to Xie (“Xie”) is directed toward an auxiliary lens assembly that couples to a primary lens assembly. Xie employs both a mechanical hook on the auxiliary bridge as well as a magnetic attachment assembly at or near the nose piece.

U.S. Pat. No. 6,761,449 to Xie is directed toward magnetically coupling an auxiliary lens assembly to a primary lens assembly. A pair of arms or retainers extending from the auxiliary bridge having magnets therein are employed to couple the auxiliary lens assembly to the primary lens assembly at or near the primary bridge.

U.S. Patent Application No. 2001/0035934 to Jagasia is directed toward a U-type hook structure in conjunction with a magnetic attachment assembly to secure an auxiliary lens assembly to a primary lens assembly included in the auxiliary bridge.

U.S. Pat. No. 6,375,321 to Lee et al. is directed toward an auxiliary lens assembly that magnetically couples to a primary lens assembly through hook-like magnetic attachment assemblies.

U.S. Pat. No. 6,139,142 to Zelman is directed toward a magnetic attachment assembly and hooks to secure an auxiliary lens assembly to a primary lens assembly.

U.S. Patent Application No. 2005/0078270 to Chow is directed toward a mechanical bridge clip that couples an auxiliary lens assembly to a primary lens assembly.

U.S. Pat. No. 6,062,688 to Vinas is directed toward a foam auxiliary assembly that couples to the rear of a primary lens assembly to form a protective barrier in the gap between the eye and the primary lenses.

The disadvantage of these conventional designs is that there are a limited number of aesthetically pleasing designs, having limited appeal for a narrow group of consumers. Additionally, because of the required uses of ferromagnetic metals, the cost of manufacturing remains high due to the numerous extraneous parts and soldered assemblies.

Thus, it can thus be seen that there is a need to develop a design for a combined lens assembly that is attachable without the numerous extraneous parts and soldered assemblies of traditional designs, which encumber their appearance and limit the lens width. There is also a need to provide a system capable of magnetic support in which the magnetic force is sufficient to support attachment of the auxiliary lens assembly to the primary lens assembly without the requirement of coextensively aligned mechanical engagement. There is also a need to simplify the structure and assembly of primary lens assemblies. There is also a need to provide a magnetically attachable auxiliary lens assembly that is light-weight. There is also a need to provide an auxiliary lens assembly that is easily attachable to the primary frame assembly, without the need to maneuver extraneous component assemblies into engagement.

### SUMMARY OF THE INVENTION

It can be seen that the present invention provides a number of benefits over more conventional designs. Specifically, because of the use of inserts, additional material can be used to comprise the primary frames such as zylonite, polycarbonate, cellulose propionate, rubber carbon fiber, polyamide, optyl, as well as diamagnetic and paramagnetic materials. Thus, the primary lens assembly can be used with magnetic auxiliary lens assemblies, such as auxiliary lens assembly, while maintaining a higher degree of flexibility with respect to aesthetic choice than was previously attainable. Moreover, as a result of the increased number of aesthetically pleasing designs, a greater appeal can be provided to wider variety of consumers. Additionally, the ability to use plastics or other composites instead of metals, not only increases the design flexibility, but also decreases the costs because of the low production costs often associated with these materials.

A primary lens assembly is provided in accordance with a preferred embodiment of the present invention. The primary lens assembly comprises a primary frame comprised of a non-magnetically attractable material and a plurality of magnetically attractable inserts embedded therein.

In some other preferred embodiment of the present invention, the magnetically attractable inserts are comprised of stainless steel and nickeless stainless steel.

In another preferred embodiment of the present invention, the magnetically attractable inserts are embedded along the perimeter of each rim of the primary frame.

In another preferred embodiment of the present invention, the non-magnetically attractable material is selected from the group consisting of zylonite, polycarbonate, cellulose propionate, rubber carbon fiber, polyamide, and optyl.

An eyewear assembly is also provided in accordance with a preferred embodiment of the present invention. The eyewear assembly comprises a primary lens assembly that includes a pair of primary lenses and a primary frame comprised of a non-magnetic material that secures the primary lenses in fixed positions relative to one another and having a plurality of magnetically attractable inserts embedded therein. An auxiliary lens assembly is also provided that comprises a pair of auxiliary lenses and an auxiliary frame having at least one magnet embedded therein to magnetically couple to the inserts.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of an auxiliary lens assembly coupled to a primary lens assembly in accordance with a preferred embodiment of the present invention.

FIG. 2 is an exploded isometric view illustrating the auxiliary lens assembly uncoupled from the primary lens assembly of FIG. 1.

FIG. 3 is a side cross-sectional view of FIG. 1.

FIG. 4 is an isometric view of the auxiliary lens assembly of FIG. 1 in an alternative embodiment.

### DETAILED DESCRIPTION OF THE PREFERRED EMBODIMENTS

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail.

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

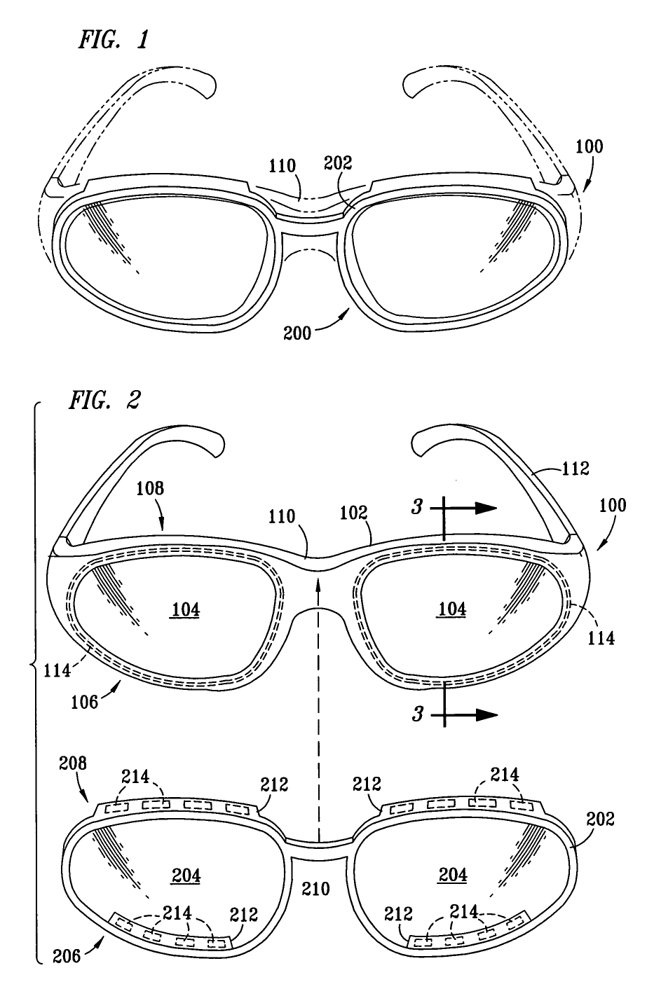

FIGS. 1 and 2 are isometric views of a primary lens assembly 100 coupled to an auxiliary lens assembly 200. Primary lens assembly 100 comprises a primary frame 102 and a pair of primary lenses 104. Primary frame 100 also includes a front 106 and a back 108. Auxiliary lens assembly 200 couples to primary lens assembly 100 on front 106. Back 108 is positioned in a direction toward the face of the wearer.

As can also be seen in FIGS. 1 and 2, primary frame 102 includes a primary bridge 110 and a pair of arms 112. Primary bridge 110 is located between primary lenses 104 so that primary lenses 104 maintain a fixed position relative to one another. Each of arms 112 extends from an end of primary frame 102 to rest over the ears of the wearer when in use.

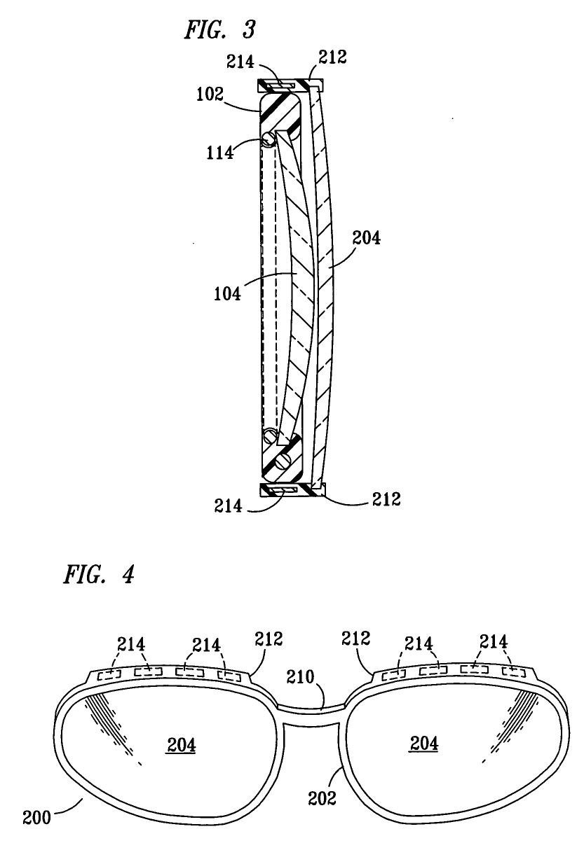

In FIGS. 2 and 3, primary frame 102 includes inserts 114 around each of primary lenses 104. Typically, primary frame 102 is comprised of a non-magnetically attractable substance, such as zylonite or zyl. Inserts 114, however, are comprised of a magnetically attractable substance, such as stainless steel or a nickeless stainless steel.

As can also be seen in FIGS. 1 and 2, auxiliary lens assembly 200 comprises an auxiliary frame 202 and a pair of auxiliary lenses 204. Auxiliary frame 200 also includes a front 206 and a back 208, where back 208 faces primary lens assembly 100 when in use.

As also disclosed in FIGS. 1 and 2, auxiliary frame 202 include an auxiliary bridge 210 and shelves 212. Auxiliary bridge 210 is located between auxiliary lenses 204 so that auxiliary lenses 204 maintain a fixed position relative to one another. Additionally, when in use, auxiliary lenses 204 are in substantial alignment with primary lenses 104. In a prefferd embodiment, shelves 212 extend from the periphery of auxiliary frame 202 to a position around the periphery of primary frame 102 when in use.

As illustrated in FIGS. 2 and 4, shelves 212 include magnets 214 embedded therein. Typically, magnets 214 are comprised of a magnetic material to magnetically couple to inserts 114 when in use.

### OPERATION OF THE PREFERRED EMBODIMENTS

The various embodiments disclosed herein which include magnetic attraction will be appreciated by one of ordinary skill in the art to involve a combination of magnet-to-magnet engagement, or magnet-to-magnetic material engagement. “Magnetic material” as used herein is defined as materials subject to attraction by magnetic force, or magnetically attractable.

Referring to FIGS. 1 through 4 of the drawings, the reference numeral 100 generally designates a primary lens assembly and the reference numeral 200 generally designates an auxiliary lens assembly.

Primary lens assembly 100 is commonly known and referred to as a pair of glasses. Primary lens assembly 100 includes a pair of arms 112 that extend from the periphery in a direction toward the face of the wearer and to rest over the ears of the wearer.

In addition to having arms 112 to support primary lens assembly 100, a primary bridge 110 is included that rests over the nose of the wearer. Primary bridge 110 not only provides support for primary frame 102 over the face of the wearer, but also secures primary lenses 104 in fixed positions relative to one another, generally over the eyes of the wearer while in use.

When desired, auxiliary lens assembly 200 can be coupled to primary lens assembly 100. When coupled, auxiliary lenses 204 are in substantial alignment with primary lenses 104. Alignment of auxiliary lenses 204 is a result of auxiliary frame 202 having an auxiliary bridge 210 to secure auxiliary lenses in fixed positions relative to one another.

The coupling between auxiliary lens assembly 200 and primary lens assembly 100 is achieved by a magnetic coupling force. Along the periphery of primary frame 102 surrounding each of primary lenses 104 are inserts 114. Inserts 114 in primary frame 102 are generally comprised of stainless steel or nickeless stainless steel. However, one of ordinary skill in the art would well appreciate that another magnetically attractable material could replace either of the stainless steels. To magnetically couple to inserts 114, shelves 212 can be employed having magnets 214 embedded therein. As can be seen in FIG. 2, shelves 212 and magnets 214 are located above and below auxiliary lenses 204; however, as shown in FIG. 4, shelves 212 are located in positions above auxiliary lenses 204. Additionally, one of ordinary skill in the art would appreciate that shelves 212 could surround a substantial portion of the periphery of primary lenses 204.

Typically, magnets 214 are micromagnets. Micromagnets are magnets that are not pressed into individual magnets. Instead, micromagnets are magnets that are pressed into blocks that are larger than the final desired size. The larger, pressed magnets are then sectioned to the desired size. Conventional industry specifications for the sizes of such micromagnets that have consistent magnetic properties are 3 mm wide by 1 mm long by 0.5 mm in thick, where the thickness is in the direction of force.

In another configuration, micromagnets that comprise magnets 214 are made of a Rare-Earth 2 Transition Element having a Maximum Energy Product of at least 210 kJ/m³. In still another configuration, micromagnets are made of an alloy comprising between 22 and 29 percent by weight samarium. Other alloys can also be employed, such as those magnets formed of Rare Earth Cobalt 5 alloys, Rare Earth Iron alloys, and International Electrotechnical Commission (IEC) Code Reference R4-1 materials.

Employing micromagnets as magnets 214 as specified would enjoy the benefit or resistance to oxidation without the need for plating. Because of their small size, plating of micromagnets can cause geometric inconsistencies that negatively affect their ability to be located in slots having complementary geometries.

Therefore, it can be seen that the present invention provides a number of benefits over more conventional designs. Specifically, because of the use of inserts 114, additional material can be used to comprise the primary frame 102 such as zylonite, polycarbonate, cellulose propionate, rubber carbon fiber, polyamide, and optyl. It can also be appreciated that a variety of non-magnetic materials, which include dielectric, diamagnetic, and paramagnetic materials, can be used to form primary lens assembly 100. Thus, the primary lens assembly 100 can be used with magnetic auxiliary lens assemblies, such as auxiliary lens assembly 200, while maintaining a higher degree of flexibility with respect to aesthetic choice than was previously attainable. Moreover, as a result of the increased number of aesthetically pleasing designs, a greater appeal can be provided to a wider variety of consumers. Additionally, the ability to use plastics or other composites, instead of metals, not only increases the design flexibility, but also decreases costs because of the low production costs often associated with these materials.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. An eye wear assembly comprising:
a primary lens assembly having a primary frame made of non-magnetically attractable material;
a pair of primary lenses secured to the primary frame in fixed relationship;
a magnetically attractable insert embedded in the primary frame such that the insert is not visible when viewed from a front side of the primary frame;
an auxiliary lens assembly having an auxiliary frame; and
a magnet embedded in the auxiliary frame in alignment for magnetic coupling with the insert of the primary frame.

2. The eye wear assembly of claim 1, further comprising:
the magnet being a micro-magnet.

3. The eyewear assembly of claim 1, further comprising:
the magnet being a micro-magnet being made of a Rare-Earth 2 Transition Element having a Maximum Energy Product of at least 210 kJ/m3.

4. The eye wear assembly of claim 1, further comprising:
the magnet being a micro-magnet made of an International Electrotechnical Commission (IEC) Code Reference R4-1 material.

5. The eyewear assembly of claim 1, further comprising:
the magnet being a micro-magnet made of an alloy comprising between 22 and 29 percent by weight samarium.

6. The eyewear assembly of claim 1, further comprising:
the magnet being a micro-magnet less than approximately 0.55 millimeters in height, less than approximately 0.55 millimeters in width, and being at least 1.2 millimeters in length.

7. The eyewear assembly of claim 1, further comprising:
the magnet being a micro-magnet approximately 0.45 millimeters in height, less than approximately 0.45 millimeters in width.

8. The eyewear assembly of claim 1, further comprising:
the magnet being a micro-magnet approximately 0.45 millimeters in height, approximately 0.45 millimeters in width, and approximately 2 millimeters in length.

9. The eyewear assembly of claim 1, wherein the magnetically attractable inserts are comprised of stainless steel.

10. The eyewear assembly of claim 9, wherein the stainless steel is nickeless.

11. The eyewear assembly of claim 1, wherein the magnetically attractable inserts are embedded along the perimeter of each rim of the primary frame.

12. The eyewear assembly of claim 1, wherein the non-magnetically attractable material is selected from the group consisting of zylonite, polycarbonate, cellulose propionate, rubber carbon fiber, polyamide, and optyl.

13. The eyewear assembly of claim 1, wherein the non-magnetically attractable material is a diamagnetic material or a paramagnetic material.

14. A primary lens assembly comprising:
a primary frame comprised of a non-magnetically attractable material;
at least one magnetically attractable insert embedded therein; and,
wherein the insert is not visible when viewed from a front side of the primary frame.

15. The primary lens assembly of claim 14, wherein the magnetically attractable inserts are comprised of stainless steel.

16. The primary lens assembly of claim 15, wherein the stainless steel is nickeless.

17. The primary lens assembly of claim 14, wherein the magnetically attractable inserts are embedded along the perimeter of each rim of the primary frame.

18. The primary lens assembly of claim 14, wherein the non-magnetically attractable material is selected from the group consisting of zylonite, polycarbonate, cellulose propionate, rubber carbon fiber, polyamide, and optyl.

19. The primary lens assembly of claim 14, wherein the non-magnetically attractable material is a diamagnetic material or a paramagnetic material.

20. The primary lens assembly of claim 14, further comprising:
the magnetically attractable insert being a micro-magnet.

21. The eye wear assembly of claim 1, further comprising:
the magnetically attractable insert being a micro-magnet being made of a Rare-Earth 2 Transition Element having a Maximum Energy Product of at least 210 kJ/m3.

22. The eye wear assembly of claim 1, further comprising:
the magnetically attractable insert being a micro-magnet made of an International Electrotechnical Commission (IEC) Code Reference R4-1 material.

23. The eyewear assembly of claim 1, further comprising:
the magnetically attractable insert being a micro-magnet made of an alloy comprising between 22 and 29 percent by weight samarium.

24. The eyewear assembly of claim 1, further comprising:
the magnetically attractable insert being a micro-magnet less than approximately 0.55 millimeters in height, less than approximately 0.55 millimeters in width, and being at least 1.2 millimeters in length.

25. The eye wear assembly of claim 1, further comprising:
the magnetically attractable insert being a micro-magnet approximately 0.45 millimeters in height, less than approximately 0.45 millimeters in width.

26. The eyewear assembly of claim 1, further comprising:
the magnetically attractable insert being a micro-magnet approximately 0.45 millimeters in height, approximately 0.45 millimeters in width, and approximately 2 millimeters in length.
